(19) United States
(12) Patent Application Publication
(10) Pub. No.: US 2026/0312443 A1
(43) Pub. Date: Oct. 8, 2026

(54) AXIAL FLOW MACHINE HAVING A STATOR AND OPTIMIZED COOLING OF THE POLE SHOES

(71) Applicant: Schaeffler Technologies AG & Co. KG, Herzogenaurach (DE)

(72) Inventors: Christian DINGER, Achern (DE); Stephan MAIENSCHEIN, Baden-Baden (DE); Toros GULLUK, Lichtenau (DE)

(73) Assignee: Schaeffler Technologies AG & Co. KG, Herzogenaurach (DE)

(21) Appl. No.: 19/476,037

(22) PCT Filed: Apr. 5, 2024
(86) PCT No.: PCT/DE2024/100279

§ 371 Date: Oct. 16, 2025

(30) Foreign Application Priority Data
Apr. 19, 2023 (DE) 10 2023 109 865.9

(51) Int. Cl. H02K 1/20; H02K 1/14; H02K 3/24

(52) U.S. Cl. CPC H02K 1/20; H02K 1/146; H02K 3/24

(57) ABSTRACT

The invention relates to a stator (1) for an axial flow machine (2), having a stator tooth (3), which is surrounded by a conductor (5) arranged in the form of windings (4), wherein the windings (4) are arranged on the outer side (6) of the stator tooth (3), wherein means (7) are inserted in order to keep a cooling channel (8) free between the stator tooth (3) and the winding (4). The invention also relates to an axial flow machine (2) having a rotor (15), which cooperates with said stator (1) during operation.

### CROSS-REFERENCE TO RELATED APPLICATIONS

This application is the U.S. National Phase of PCT Appln. No. PCT/DE 2024/100279, filed Apr. 5, 2024, which claims the benefit of German Patent Appln. No. 102023109865.9, filed Apr. 19, 2023, the entire disclosures of which are incorporated by reference herein.

### TECHNICAL FIELD

The disclosure relates to a stator for an axial flow machine, having a stator tooth, which is surrounded by a conductor arranged in the form of turns, wherein the turns are arranged on the outer side of the stator tooth.

### BACKGROUND

Demand for axial flow machines has increased in recent years, mainly due to the advantages presented by their shorter axial length, which saves on installation space and costs, but also due to their high efficiency, which allows higher torques and a higher power density to be achieved compared to machines of radial construction. An axial flow machine is primarily characterized by a disk-shaped construction of the stators and rotors, the number of stators and rotors used varying depending on the structure selected for the axial flow machine. It is known for stator teeth to be provided on the stator, more precisely on the stator yoke, these being formed, for example, as laminated cores in order to reduce the losses that come with heating, for example eddy current losses. A pole shoe is provided on the stator tooth, which allows the magnetic field lines of the conductor wound around the stator tooth to emerge and distributes them to the rotor. As a rule, the pole shoe is anchor-shaped. The pole shoe is not enclosed by the excitation winding. If the stator tooth is enclosed by windings, the windings lie close to the stator tooth and accordingly also close to the pole shoe. Since the winding fits very closely against the stator tooth, cooling is necessary to reduce heating and to further minimize the losses that come with heating.

### SUMMARY

The object of the present disclosure is to eliminate or at least partially alleviate the disadvantages mentioned. The focus is on improved cooling of the pole shoes.

This is solved for a stator of the above type for an axial flow machine in that structures are used in order to keep a cooling channel free between the stator tooth and the turn. In order to form the cooling channel between stator tooth and turn, it is necessary at least to create a space between stator tooth and turn. This space can then be used to direct cooling fluid to the pole shoe via a cooling oil supply.

Advantageous embodiments are claimed in the subclaims and are explained in greater detail below.

Furthermore, the structures may comprise at least one distance piece and/or be determined by the arrangement of the turns on the outer side of the stator tooth. There are therefore various options for implementing the cooling channel. The distance piece provides an additional element in the assembly that creates the space between turn and stator tooth. Depending on the embodiment, the distance piece may be fastened to various elements of the stator. The arrangement of the turns provides a further solution that eliminates the need for additional elements, thus avoiding the redesign of existing elements. For a particularly reliable design of the space between turn and stator tooth, it is possible to combine the two solutions involving the distance piece and the arrangement of the turn. This allows for a flexible design, depending on the application.

In addition, the distance piece may be an integral part of the stator tooth, basic insulation of the winding, an insulation layer of the stator tooth or a stator cover, or the winding may be aligned mutually and relative to the surface of the stator tooth in such a way that the cooling channel is enforced. If the distance piece is provided as an integral part of the stator tooth, then it is formed, for example, directly on the pole shoe during the process of manufacturing the pole shoe. The distance piece is preferably embodied in the form of a raised portion. In cross-section, the geometric shape of the raised portion is, for example, rectangular, semicircular or tapered. The height of the distance structures, which defines the size, for example the length in the radial direction of the cooling channel, among other things, must be designed according to the amount of cooling oil flow required. Accordingly, the space between stator tooth and winding can be larger or smaller. If the distance piece is provided on the basic insulation of the winding, it is formed directly by the overmolding of the wound conductor resulting from production of the basic insulation. If additional insulation is provided on the stator tooth, for example as a result of slot insulation, the insulation layer may be embodied directly with distance pieces. The distance piece may likewise be provided directly on the stator cover, with the distance piece likewise being provided directly on the stator cover during the manufacturing process thereof. If the space between turn and stator tooth is implemented without a physical distance piece, then it is implemented by the mutual positioning of the winding and the positioning of the winding relative to the surface of the stator tooth. Different arrangements can be implemented depending on winding type, for example whether it is a single-layer or two-layer winding.

It is advantageous for the distance piece to project in the axial and/or radial direction. Depending on the embodiment, a combination or plurality of distance pieces formed in the axial and radial directions is possible. If the distance piece is preferably embodied as an integral part of the stator tooth in the form of a raised portion, it is positioned in the radial direction on the side facing the windings. If the distance piece is provided on the stator cover, then it has a raised portion comparable to the above-mentioned embodiment on the stator tooth. A combination of axial direction and radial direction can be implemented, for example, in the case of the embodiment of the distance pieces as an integral part of the basic insulation of the winding. To position the winding between stator yoke and pole shoe and to provide the cooling channel, distance pieces formed on the basic insulation are provided between the basic insulation and the underside of the pole shoe as well as between the top side of the stator yoke and the basic insulation. To space the winding relative to the outer side of the stator tooth, further distance pieces are provided on the basic insulation in the axial direction, which space the winding including the basic insulation from the stator tooth. It is advantageous for at least two distance pieces to be provided in the axial direction to ensure a stable arrangement.

It is advantageous for the windings to be placed obliquely relative to the radial and axial directions. With a simple winding (single-layer), the windings are inclined obliquely relative to the underside of the pole shoe, so enforcing a cooling channel. With a double winding (two-layer), the two layers of the windings can be positioned differently from each other. For example, the inner winding may be offset relative to the outer winding, creating a cavity to the pole shoe that can be used as a cooling channel. Omitting an element in the form of the distance piece as a means of keeping the cooling channel clear means there is one less wearing part.

It is furthermore advantageous for the distance piece to run at least partially between two turns or to act centrally on one turn. If the distance pieces are arranged in the axial direction, the distance pieces can be formed in such a way that they create a space between the turns. In one advantageous embodiment, one or more distance pieces are formed on the insulation layer on the stator tooth. Depending on the application, the distance pieces have different shapes that act on one turn or run between two turns. With a first distance piece, a space may be created between two turns, preferably the turn oriented toward the underside of the pole shoe and the turn adjacent thereto. Further distance pieces may be positioned between the further turns. Preferably, the distance piece has a tapered shape, for example a tip, so that the conductor with the turns is more readily attached and secured, and the cooling channel is thereby provided. In one further embodiment, a distance piece acts centrally on a turn so that the latter projects beyond the other turns in the axial direction and exposes a cooling channel.

Furthermore, the distance piece may act on multiple turns. If the distance piece is embodied in such a way that it acts centrally on one turn, the respectively adjacent turns can be spaced radially relative to the one turn by the shape of the distance piece. If the side surfaces of the distance piece are beveled/inclined, this causes offset of the adjacent turns and of the positioning of the winding between pole shoe and stator yoke.

It is advantageous for at least one distance piece to be oriented in the axial direction and for at least one further distance piece to be oriented in the radial direction. The above-described embodiments for providing the cooling channel using the structures are mutually combinable.

In addition, the winding may have local shaped portions for providing at least one of the distance pieces. The local shaped portions are here formed on the turn of the conductor winding oriented toward the underside of the pole shoe. The local shaped portions are provided in a transverse direction along the turn, such that the turn forms an undulating profile, for example, which provides the cooling channel. Omitting an element in the form of a molded-on distance piece as a means of keeping the cooling channel clear means there is one less wearing part.

In one further advantageous embodiment, the pole shoe is a separate element from the stator tooth. The pole shoe may in this case be connected separately to the stator tooth in the form of edge elements or in the form of a pole shoe plate, wherein the edge elements and the pole shoe plate are dimensioned such that they project beyond the stator tooth in each case in both directions in the axial direction in order to reproduce the anchor-shaped form in combination with the stator tooth. If the stator tooth and pole shoe are mutually separate elements, the pole shoe may, for example, be injected into the stator cover, so simplifying the arrangement relative to the stator tooth.

In addition, a cooling channel may be formed in the form of a cooling slot formed in the pole shoe. These are recesses in the pole shoe which allow the cooling oil to flow behind the pole shoe to the stator teeth. If the stator teeth are made from electric sheet steel stacks, it is possible to create these channels by selectively punching out a few adjoining sheet layers.

The disclosure also relates to an axial flow machine with a rotor which cooperates with a stator during operation.

Various advantageous embodiments of the disclosure are explained in greater detail below with reference to drawings comprising figures.

### BRIEF DESCRIPTION OF THE DRAWINGS

In the drawings:

FIG. 1 shows an axial flow machine having a stator according to the disclosure,

FIG. 2 shows a stator half of the stator according to the disclosure of FIG. 1,

FIG. 3 shows the stator half including windings around individual stator teeth,

FIG. 4 is a sectional representation of an individual stator tooth with overmolded winding,

FIG. 5 is a detail view according to FIG. 4 with cooling channel by way of distance pieces,

FIG. 6 shows the stator tooth according to FIG. 4 with overmolded two-layer winding,

FIG. 7 shows the distance piece provided on the pole shoe of the stator tooth,

FIG. 8 shows the distance piece provided on an insulation layer of the stator tooth in the radial direction,

FIG. 9 shows the distance piece provided on an insulation layer of the stator tooth and arranged between two turns,

FIG. 10 shows a plurality of distance pieces provided on the insulation layer of the stator tooth in the axial direction and arranged between the turns,

FIG. 11 shows the distance piece provided on the insulation layer of the stator tooth and acting centrally on a turn,

FIG. 12 shows the stator tooth with separate pole shoes in the form of edge elements with a cooling channel according to FIG. 6,

FIG. 13 shows the stator tooth with separate pole shoes in the form of a pole shoe plate with a cooling channel according to FIG. 6,

FIG. 14 shows the distance piece on the pole shoe edge or pole shoe plate,

FIG. 15 shows a first embodiment of the distance piece provided on the stator cover with injected pole shoe,

FIG. 16 shows the distance piece provided on the stator cover with filled cavity,

FIG. 17 shows a two-layer winding with an offset outer turn applied against the pole shoe,

FIG. 18 shows pole shoe cooling by way of cooling slots in the pole shoe,

FIG. 19 shows pole shoe cooling by way of slightly inclined turns,

FIG. 20 shows a second embodiment of the distance piece provided on the stator cover with injected pole shoe,

FIG. 21 shows the cooling channel provided by way of local shaped portions in the turn,

FIG. 22 is a side view of the cooling channel according to FIG. 21.

### DETAILED DESCRIPTION

The figures are merely schematic in nature and serve solely to assist in understanding the disclosure. Identical elements are provided with the same reference signs. Features of the individual embodiments can be interchanged and used as alternatives/cumulatively.

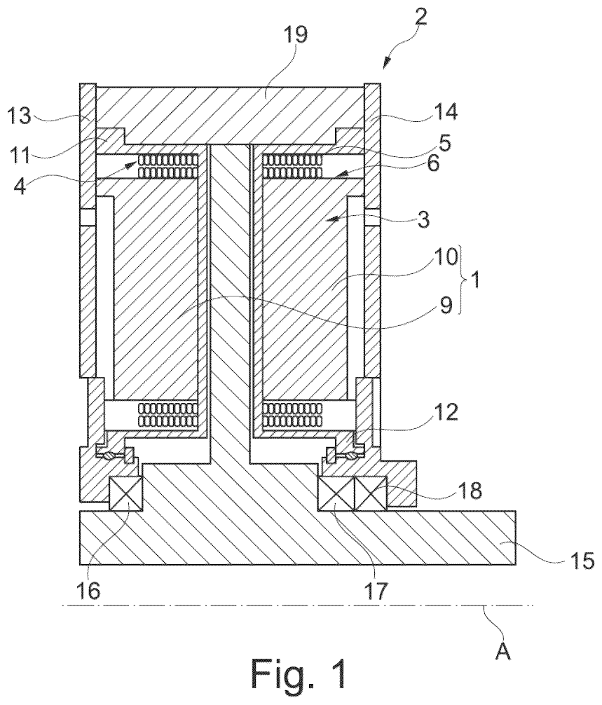

FIG. 1 shows a stator 1 according to the disclosure for an axial flow machine 2, FIG. 1 showing the complete assembly of said axial flow machine 2. The stator 1 has a stator tooth 3 which is surrounded by a conductor 5 arranged in the form of turns 4, wherein the turns 4 are arranged on the outer side 6 of the stator tooth 3.

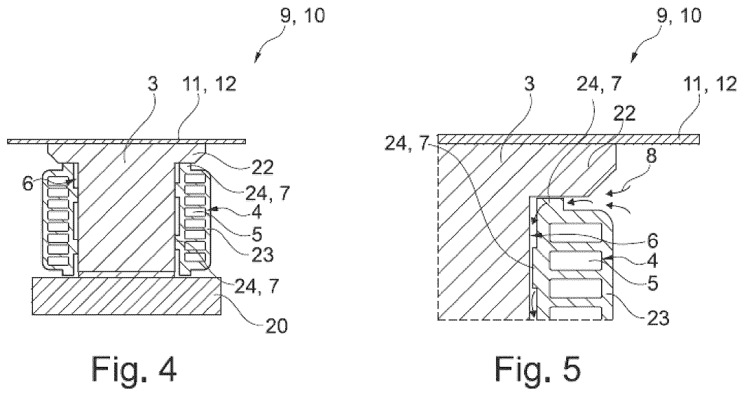

Structures 7 (shown in FIG. 4) are used to keep a cooling channel 8 (shown from FIG. 5 onward) free between the stator tooth 3 and the turn 4. The stator 1 is arranged along an axis of rotation A. The stator 1 has two stator halves 9, 10, a left stator half 9 and a right stator half 10. The left stator half 9 and the right stator half 10 have conductors 5 with turns 4. The stator halves 9, 10 are surrounded in each case by a stator cover 11, 12 and a housing cap 13, 14, the stator halves 9, 10 being connected to the respective associated housing caps 13, 14. A rotor 15 is arranged between the stator covers 11, 12, and thus also between the stator halves 9, 10. The housing caps 13, 14 are mounted on the rotor 15 by way of bearings 16, 17, 18. In the radially outer area, a spacer 19 is provided between the housing caps 13, 14.

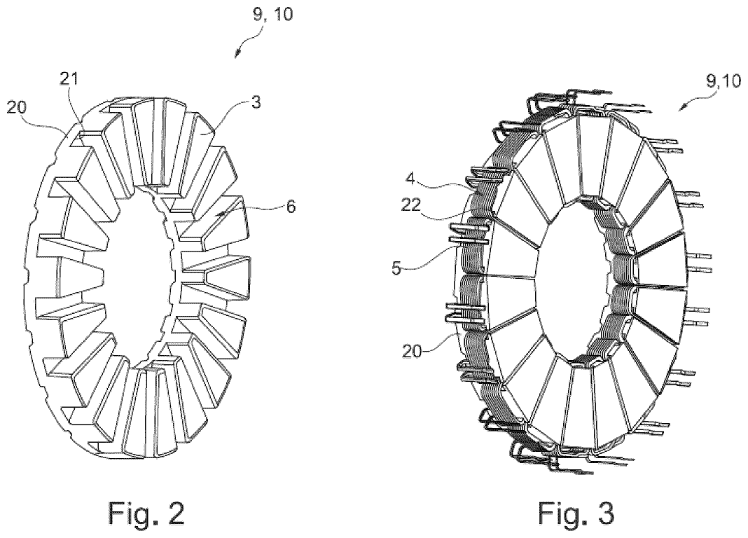

FIG. 2 then shows the structure of the stator halves 9, 10 of the stator 1. The stator half 9, 10 has a stator yoke 20 on which the individual stator teeth 3 are arranged in the circumferential direction. Slots 21 are provided between the individual stator teeth 3, keeping the space between the individual stator teeth 3 free for the conductors 5 wound into turns 4.

In FIG. 3, the stator half 9, 10 known from FIG. 2 is arranged with conductors 5 wound with the turns 4 on the stator teeth 3. In addition, each stator tooth 3 now has a pole shoe 22. The pole shoes 22 rest on the upper surface of the respective stator tooth 3 and delimit the winding.

FIG. 4 shows an individual, sectional view of a stator tooth 3. In the embodiment shown, the conductor 5 with its turns 4 is shown in overmolded form. This overmolding provides the conductor 5 with basic insulation 23. The structures 7, here in the form of distance pieces 24, are then provided on this basic insulation 23. In the present embodiment, the distance pieces 24 are provided radially and axially on the basic insulation 23. The distance pieces 24 in the radial direction are each formed with a raised portion on the basic insulation 23 between the wound conductor 5 and the underside of the pole shoe 22 and on the other side between the wound conductor 5 and the top side of the stator yoke 20. The distance pieces 24 in the axial direction are formed on the basic insulation 23 between the wound conductor 5 and the outer side 6 of the stator tooth 3 and are spaced apart from one another in the radial direction.

In FIG. 5, the arrangement known from FIG. 4 is shown in a detailed representation with respect to the distance pieces 24 embodied as structures 7. The distance pieces 24 enable an optimized cooling oil supply via the cooling channel 8. The path of the cooling channel 8 runs between the underside of the pole shoe 22 and the opposite turn 4 of the wound conductor 5 in the axial direction to the outer side 6 of the stator tooth 3, and then in the radial direction along this outer side 6 in the direction of gravity from top to bottom.

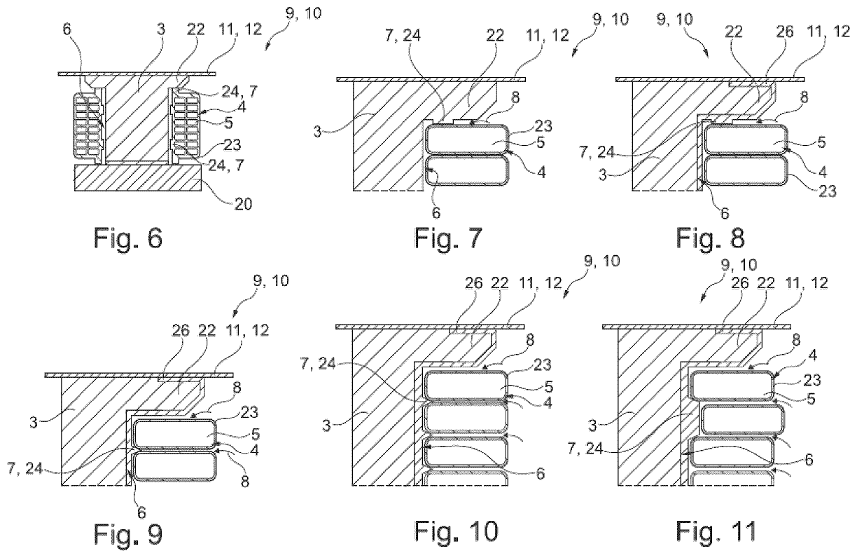

FIG. 6 shows a further embodiment of the arrangement known from FIG. 4 with the distance pieces 24 used as structures 7. The second embodiment shows the conductor 5 in a double winding. The double winding of conductor 5 is characterized by the winding being two-layer in the axial direction. The design of the distance pieces 24 corresponds to that shown in FIG. 4

In FIG. 7, the distance piece 24 is formed directly on the underside of the pole shoe 22. In the embodiment shown, the distance piece 24 is arranged between the pole shoe 22 and the turn 4 of the conductor 5. The cooling channel 8 is formed with the aid of the distance piece 24. In comparison with the previous two embodiments, in this embodiment shown in FIG. 7 the conductor 5 is not present in overmolded form, the basic insulation 23 nonetheless being retained around the conductor 5.

In FIG. 8, the distance piece 24 is formed on the stator tooth 3 with the aid of an insulation layer 26. The insulation layer 26 begins in part at the surface of the stator tooth 3 and then runs along the contour of the pole shoe 22 on the underside of the pole shoe 22 toward the outer side 6 of the stator tooth 3, following radially in the direction of gravity downward along this outer side 6. The distance piece 24, which is formed on the insulation layer 26 of the stator tooth 3, is again arranged between pole shoe 22 and conductor 5. The cooling channel 8 corresponds to the cooling channel 8 from the previous embodiment according to FIGS. 6 and 7.

In FIG. 9, the distance piece 24 is again formed on the insulation layer 26 of the stator tooth 3, but with the difference that the distance piece 24 is arranged between the turns 4 of the conductor 5. The distance piece 24 here adopts the shape of a tapered tip to provide a “snap-fit”. The wound conductor 5 is also secured with this snap-fit and creates a space between two turns 4 and between pole shoe 22 and turn 4, so forming the cooling channel 8.

In FIG. 10, the embodiment known from FIG. 9 of distance pieces 24 arranged between two turns 4 of the conductor 5 is extended to a second embodiment by arranging distance pieces 24 in the form of the aforementioned snap-fits between each turn 4 of the conductor 5 and forming them directly on the insulation layer 26 of the stator tooth 3. The cooling channels of FIG. 9 are thus extended by cooling channels 8 between each adjacent turn 4.

FIG. 11 shows a further embodiment of the distance piece 24 already known from FIGS. 9 and 10, which is formed merely from the insulation layer 26 of the stator tooth 3. The distance piece 24 protrudes axially and is positioned centrally relative to one of the turns 4, in the embodiment shown in the radial direction of the second turn 4 from the top, such that this turn 4 of the conductor 5 protrudes from the ordered shape and is displaced axially relative to the other turns 4. The distance piece 24 has an oblique/inclined chamfer at both side surfaces, whereby the adjacent turns 4 of the displaced turn 4 are likewise spaced from one another in the radial direction. This larger, wider shape of the distance piece 24 holds the wound conductor 5 in position. By displacing the winding 4, the cooling channels 8 are formed, which run between the windings 4.

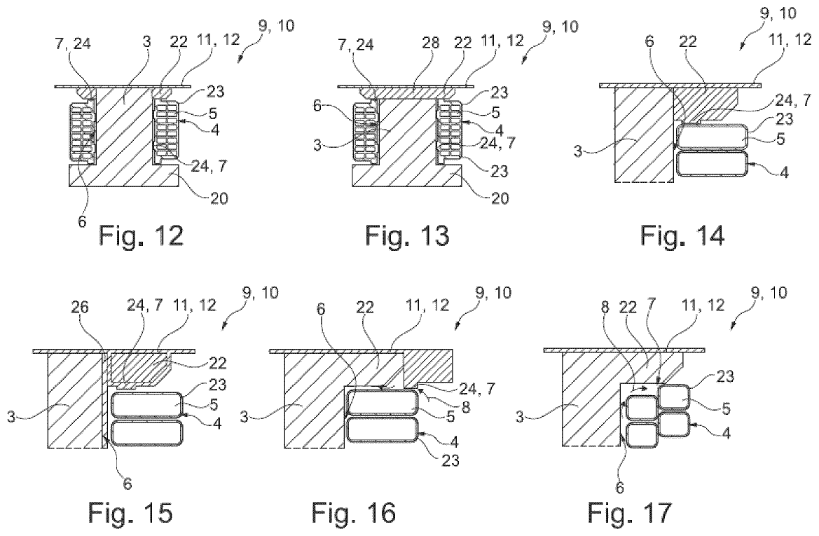

In FIG. 12, the stator tooth 3 is shown with separate pole shoes 22 in the form of edge elements. In the present embodiment, the pole shoes 22 are formed as a separate component from the stator tooth 3. The pole shoes 22 are connected to the stator tooth 3. The stator tooth 3 and the stator yoke 20 are embodied together in one piece. The embodiment of the distance pieces 24 is identical to the embodiment of FIG. 6.

In FIG. 13, the pole shoes 22 are formed by way of a pole shoe plate 27.

The pole shoe plate 27 is formed such that it extends in the axial direction beyond the stator tooth 3, so that the extension projecting in the axial direction relative to the stator tooth 3 represents the pole shoe 22.

In FIG. 14, the distance piece 24 is formed on the pole shoe 22 according to FIG. 7 and the pole shoe is provided according to FIG. 12. In a further embodiment, the distance piece 24 may likewise be formed on the pole shoe 22 according to FIG. 13 from the pole shoe plate 27. The course of the cooling channel 8 corresponds to the arrangement of FIG. 7.

In FIG. 15, the distance piece 24 is formed on the stator cover 11, 12. The stator cover 11, 12 is provided around the pole shoe 22. In order to insulate the pole shoe 22 with the aid of the stator cover 11, 12, the pole shoe 22 may be injected into the stator cover 11, 12. The positioning and shape of the distance piece 24 corresponds to the distance piece 24 according to FIG. 7.

FIG. 16 shows an embodiment in which the distance piece 24 is embodied solely on the stator cover 11, 12 and, in comparison to FIG. 15, the pole shoe 22 is not overmolded by the stator cover 11, 12. The stator cover 11, 12 is embodied such that, as in the previous embodiments up to FIG. 14, it not only rests radially above on the pole shoes 22, but in this embodiment the stator cover 11, 12 fills a cavity which is formed between the pole shoes 22 of two different, adjacent stator teeth 3. The distance piece 24 is positioned such that it is positioned toward the outer edge of the turns 4 of the conductor 5. The cooling channel 8 runs between the upper turn 4 and the underside of the pole shoe 22.

In FIG. 17, the cooling channel 8 is formed by means of the differently arranged turns 4 of the conductor 5. The conductor 5 is provided with a two-layer turn 4. The inner turns 4 of the conductor 5 form, through an offset relative to the outer windings 4 of the conductor 5, a small cavity to the pole shoes 22, through which the cooling oil flows along the cooling channel 8.

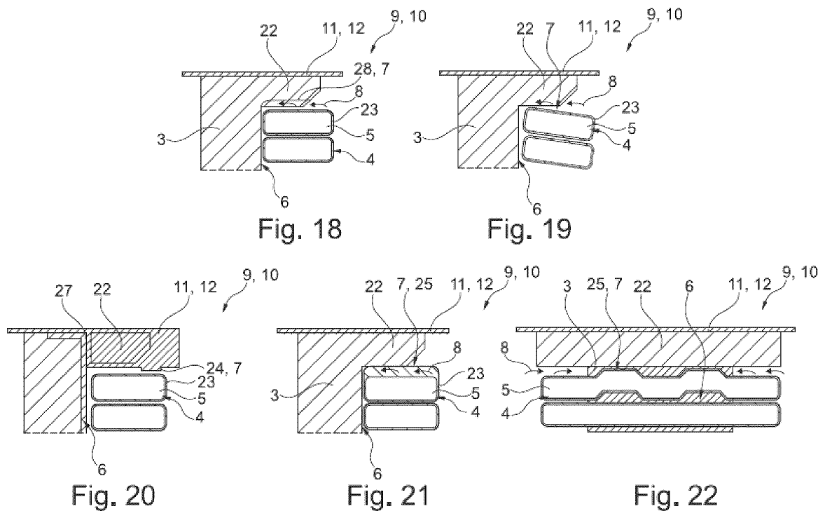

In FIG. 18, cooling is defined by the cooling channel 8 being formed by cooling slots 28. The cooling slot 28 is a recess in the pole shoe 22, which allows the cooling oil to flow behind the pole shoe 22 to the stator teeth 3.

In FIG. 19, cooling of the pole shoes 22 is implemented with the aid of inclinedly positioned turns 4. The inner part of the turns 4 is in contact with the underside of the pole shoe 22. The cooling channel 8 flows axially from the outside to the inside up to the inclined inner part of the turn 4.

In FIG. 20, the distance piece 24 is shown according to a combination of the embodiments of FIG. 15 and FIG. 16. The pole shoe 22 is here injected into the stator cover 11, 12 and the stator cover 11, 12 fills the cavity formed between the pole shoes 22 of two different, adjacent stator teeth 3. The dimensioning of the distance piece 24 is based on FIG. 15. Since, in comparison to FIG. 15, not only is the contour of the pole shoe 22 overmolded, but the entire area is filled with injected material, this area can be used to position the distance piece 24.

FIGS. 21 and 22 show a further embodiment for the formation of the cooling channel 8. In FIG. 21, local shaped portions 25 are formed in the upper turn 4 of the conductor 5, these being shown in greater detail in the side view according to FIG. 22. These shaped portions 25 are formed toward the underside of the pole shoe 22. The cooling channel 8 thus flows around the pole shoe 22. The stator tooth 3 can likewise be cooled via the cooling channel 8.

### LIST OF REFERENCE SIGNS

1 Stator
2 Axial flow machine
3 Stator tooth
4 Turn
5 Conductor
6 Outer side
7 Structures
8 Cooling channel
9 Left stator half
10 Right stator half
11 Left stator cover
12 Right stator cover
13 Left housing cap
14 Right housing cap
15 Rotor
16 Bearing
17 Bearing
18 Bearing
19 Spacer
20 Stator yoke
21 Stator slot
22 Pole shoe
23 Basic insulation
24 Distance piece
25 Local shaped portion
26 Insulation layer of stator tooth
27 Pole shoe plate
28 Cooling slot
A Axis of rotation

1. A stator for an axial flow machine comprising:
a stator tooth, which is surrounded by turns of a conductor winding, wherein the turns are arranged on an outer side of the stator tooth, wherein structures are used in order to keep a cooling channel free between the stator tooth and the turns.

2. The stator according to claim 1, wherein the structures comprise at least one of at least one distance piece or the turns on the outer side of the stator tooth.

3. The stator according to claim 2, wherein the distance piece is at least one of an integral part of the stator tooth, a basic insulation of the winding, an insulation layer of the stator tooth or a stator cover, or the winding is aligned mutually and relative to a surface of the stator tooth in such a way that the cooling channel is enforced.

4. The stator according to claim 3, wherein the distance piece projects in an axial or radial direction.

5. The stator according to claim 3, wherein the windings are placed obliquely relative to both a radial and an axial direction.

6. The stator according to claim 3, wherein the distance piece runs at least partially between two turns or acts centrally on one turn.

7. The stator according to claim 3, wherein the distance piece acts on multiple turns.

8. The stator according to claim 3, wherein at least one distance piece is oriented in an axial direction and at least one further distance piece is oriented in a radial direction.

9. The stator according to claim 3, wherein the winding has local shaped portions for providing at least one of the distance pieces.

10. An axial flow machine comprising:
a rotor;
a stator which cooperates with the rotor during operation;
wherein the stator includes a stator tooth, which is surrounded by turns of a conductor winding, wherein the turns are arranged on an outer side of the stator tooth, wherein structures are used in order to keep a cooling channel free between the stator tooth and the turns.

11. The axial flow machine according to claim 10, wherein the structures comprise at least one of at least one distance piece or the turns on the outer side of the stator tooth.

12. The axial flow machine according to claim 11, wherein the distance piece is at least one of an integral part of the stator tooth, a basic insulation of the winding, an insulation layer of the stator tooth or a stator cover, or the winding is aligned mutually and relative to a surface of the stator tooth in such a way that the cooling channel is enforced.

13. The axial flow machine according to claim 12, wherein the distance piece projects in an axial or radial direction.

14. The axial flow machine according to claim 12, wherein the windings are placed obliquely relative to both a radial and an axial direction.

15. The axial flow machine according to claim 12, wherein the distance piece runs at least partially between two turns or acts centrally on one turn.

16. The axial flow machine according to claim 12, wherein the distance piece acts on multiple turns.

17. The axial flow machine according to claim 12, wherein at least one distance piece is oriented in an axial direction and at least one further distance piece is oriented in a radial direction.

18. The axial flow machine according to claim 12, wherein the winding has local shaped portions for providing at least one of the distance pieces.
